(19) United States
(12) Patent Application Publication
(10) Pub. No.: US 2025/0210010 A1
(43) Pub. Date: Jun. 26, 2025

(54) DEMURA OPTIMIZATION

(71) Applicant: QUALCOMM Incorporated, San Diego, CA (US)

(72) Inventors: Hitesh Venkata RACHAKONDA, Hyderabad (IN); Sridhar Rao NUNE, Hyderabad (IN); Olk IDAPALAPATI, Hyderabad (IN); Sri Vatsava Ganesh Kumar VEMPATI, Nellore (IN)

(21) Appl. No.: 18/394,499

(22) Filed: Dec. 22, 2023

(51) Int. Cl. G09G 5/39; G09G 3/20

(52) U.S. Cl. CPC G09G 5/39; G09G 3/2003; G09G 2320/06

(57) ABSTRACT

This disclosure provides systems, devices, apparatus, and methods, including computer programs encoded on storage media, for demura optimization. A display processor computes a distance between a mura region on a display panel and an edge of a fovea region associated with a frame that is to be displayed on the display panel. The display processor compares the computed distance to a threshold. The display processor computes an adjustment to the fovea region based on the comparison of the computed distance to the threshold. The display processor outputs an indication of the computed adjustment to the fovea region.

### TECHNICAL FIELD

The present disclosure relates generally to processing systems, and more particularly, to one or more techniques for display processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques for demura correction may be associated with a relatively high use of computational resources of a device and/or a relatively high use of power resources of the device. There is a need for improved techniques pertaining to demura correction.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus includes a memory; and a processor coupled to the memory and, based on information stored in the memory, the processor is configured to: compute a distance between a mura region on a display panel and an edge of a fovea region associated with a frame that is to be displayed on the display panel; compare the computed distance to a threshold; compute an adjustment to the fovea region based on the comparison of the computed distance to the threshold; and output an indication of the computed adjustment to the fovea region.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example graphics processor (e.g., a graphics processing unit (GPU)) in accordance with one or more techniques of this disclosure.

FIG. 3 illustrates an example display framework including a display processor and a display in accordance with one or more techniques of this disclosure.

FIG. 4 is a diagram illustrating example aspects pertaining to mura in accordance with one or more techniques of this disclosure.

FIG. 5 is a diagram illustrating an example display processor pipeline in accordance with one or more techniques of this disclosure.

FIG. 6 is a diagram illustrating an example of a display processor pipeline in accordance with one or more techniques of this disclosure.

FIG. 7 is a diagram illustrating an example of a workflow for mura correction in accordance with one or more techniques of this disclosure.

FIG. 8 is a diagram illustrating an example of demurification in accordance with one or more techniques of this disclosure.

FIG. 9 is a diagram illustrating an example of a workflow for mura correction in accordance with one or more techniques of this disclosure.

FIG. 10 is a call flow diagram illustrating example communications between a first display processor component and a second display processor component or a display panel component in accordance with one or more techniques of this disclosure.

FIG. 11 is a flowchart of an example method of display processing in accordance with one or more techniques of this disclosure.

FIG. 12 is a flowchart of an example method of display processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

A user may wear a display device in order to experienced extended reality (XR) content. XR may refer to a technology that blends aspects of a digital experience and the real world. XR may include augmented reality (AR), mixed reality (MR), and/or virtual reality (VR). In AR, AR objects may be superimposed on a real-world environment as perceived through the display device. In an example, AR content may be experienced through AR glasses that include a transparent or semi-transparent surface. An AR object may be projected onto the transparent or semi-transparent surface of the glasses as a user views an environment through the glasses. In general, the AR object may not be present in the real world and the user may not interact with the AR object. In MR, MR objects may be superimposed on a real-world environment as perceived through the display device and the user may interact with the MR objects. In some aspects, MR objects may include “video see through” with virtual content added. In an example, the user may “touch” a MR object being displayed to the user (i.e., the user may place a hand at a location in the real world where the MR object appears to be located from the perspective of the user), and the MR object may “move” based on the MR object being touched (i.e., a location of the MR object on a display may change). In general, MR content may be experienced through MR glasses (similar to AR glasses) worn by the user or through a head mounted display (HMD) worn by the user. The HMD may include a camera and one or more display panels. The HMD may capture an image of environment as perceived through the camera and display the image of the environment to the user with MR objects overlaid thereon. Unlike the transparent or semi-transparent surface of the AR/MR glasses, the one or more display panels of the HMD may not be transparent or semi-transparent. In VR, a user may experience a fully-immersive digital environment in which the real-world is blocked out. VR content may be experienced through a HMD.

Mura may refer to a low-contrast irregular pattern or region (i.e., a mura region) on a display panel that causes uneven pixel uniformity on the display panel. A pixel may refer to a smallest addressable element on a display panel. Mura may cause pixels that are intended to display the same color to display different colors, which may impact a user experience, particularly in cases of XR applications. Mura may be caused by imperfections in a manufacturing process of a display panel. Techniques that attempt to mitigate or correct mura may be referred to as “demura correction,” “mura correction,” “demurification,” etc. In an example, if a device detects mura, the device may apply demura correction to all pixels on a display panel, however, applying the demura correction may reduce a quality of a displayed frame (i.e., an image). The reduction in quality may be notable in XR contexts in which an eye of the user is relatively close to a display panel. In another example, the device may apply a low frequency component (LFC) correction and a high frequency component (HFC) correction to all pixels on the display panel in order to remove or mitigate mura; however, this may be associated with increased power usage and/or increased computational burdens on the device.

Various technologies pertaining to demura optimization are described herein. In an example, an apparatus (e.g., a display processor) computes a distance between a mura region on a display panel and an edge of a fovea region associated with a frame that is to be displayed on the display panel. The apparatus (e.g., a display processor) compares the computed distance to a threshold. The apparatus (e.g., a display processor) computes an adjustment to the fovea region based on the comparison of the computed distance to the threshold. The apparatus (e.g., a display processor) outputs an indication of the computed adjustment to the fovea region. Vis-à-vis computing an adjustment to the fovea region based on the comparison, the apparatus (e.g., a display processor) may reduce processing performed on pixels of the fovea region, which may save computational resources and/or power resources of the device.

In another example, an apparatus (e.g., a display processor) may determine that a set of pixels associated with a mura effect on a display panel is within a periphery region associated with a frame that is to be displayed on the display panel. The apparatus (e.g., a display processor) may perform a low frequency component (LFC) correction on the set of pixels and may refrain from performing a high frequency component (HFC) correction on the set of pixels based on the determination. The apparatus (e.g., a display processor) may output an indication of the performed LFC correction on the set of pixels. Vis-à-vis performing the LFC correction while refraining from performing the HFC correction based on the determination, the apparatus (e.g., a display processor) may reduce processing performed on pixels of the frame with no impact (or a minimal impact) on a quality of the frame, which may save computational resources and/or power resources of the device.

In one aspect described herein, when a pixel exhibiting a mura effect (i.e., “a mura pixel”) is in a periphery region of a display panel, a display processor of a device may perform an LFC correction without performing an HFC correction in order to save power of the device. An HFC correction may entail an allocation of a direct memory access (DMA) pipeline to read an HFC correction data layer. In one aspect described herein, a display processor may compare left top right bottom (LTRB) coordinates of a foveal region with coordinates of a pixels exhibiting mura on a display panel. When the pixels exhibiting the mura are outside of the LTRB coordinates, a defined flag may be set by a display manager (DM) and passed on to a demura block in a destination side post processing (DSPP) block. The demura block may read the flag and perform an LFC correction. LFC data may be used as an initial portion of the correction to reduce a nonuniformity to a manageable baseline level. LFC corrected pixel data may then be pushed to a display panel via Display Serial Interface (DSI) lanes.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

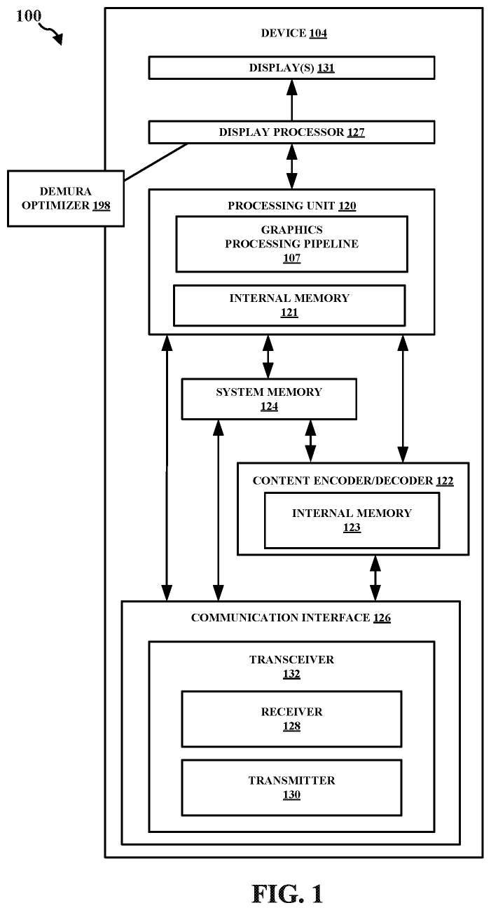

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the display processor may include a demura optimizer 198 configured to compute a distance between a mura region on a display panel and an edge of a fovea region associated with a frame that is to be displayed on the display panel; compare the computed distance to a threshold; compute an adjustment to the fovea region based on the comparison of the computed distance to the threshold; and output an indication of the computed adjustment to the fovea region. Although the following description may be focused on display processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

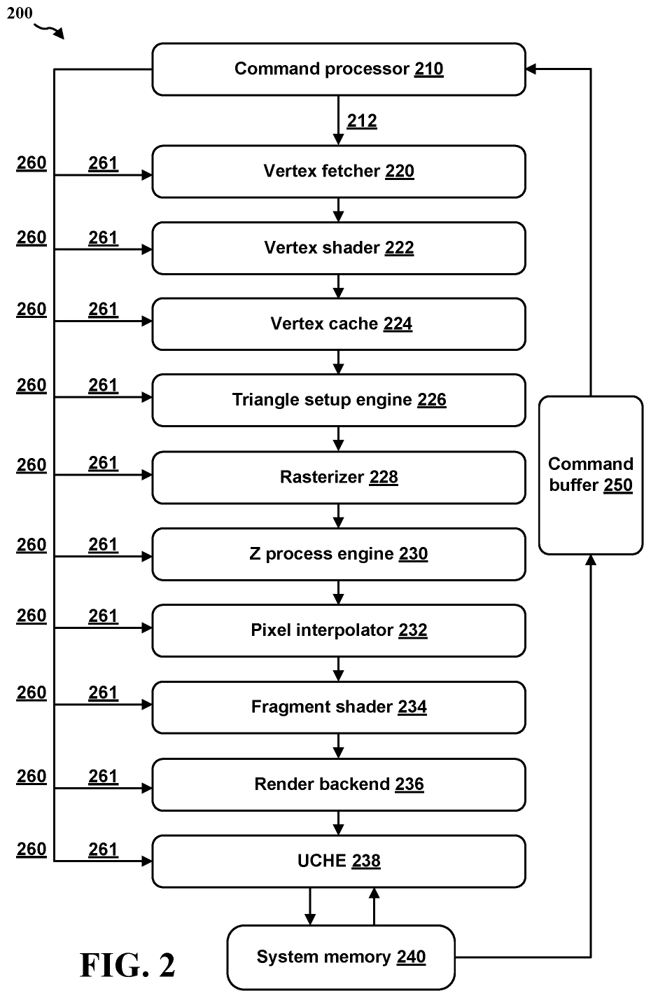

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

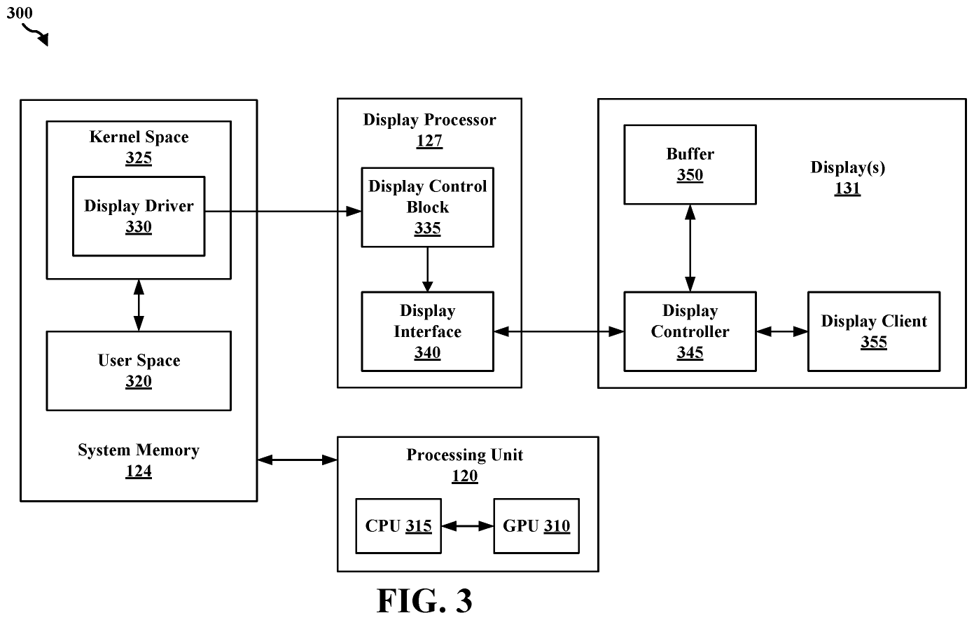

FIG. 3 is a block diagram 300 that illustrates an example display framework including the processing unit 120, the system memory 124, the display processor 127, and the display(s) 131, as may be identified in connection with the device 104.

A GPU may be included in devices that provide content for visual presentation on a display. For example, the processing unit 120 may include a GPU 310 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 310 may be controlled based on one or more graphics processing commands provided by a CPU 315. The CPU 315 may be configured to execute multiple applications concurrently. In some cases, each of the concurrently executed multiple applications may utilize the GPU 310 simultaneously. Processing techniques may be performed via the processing unit 120 output a frame over physical or wireless communication channels.

The system memory 124, which may be executed by the processing unit 120, may include a user space 320 and a kernel space 325. The user space 320 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 325 may further include a display driver 330. The display driver 330 may be configured to control the display processor 127. For example, the display driver 330 may cause the display processor 127 to compose a frame and transmit the data for the frame to a display.

The display processor 127 includes a display control block 335 and a display interface 340. The display processor 127 may be configured to manipulate functions of the display(s) 131 (e.g., based on an input received from the display driver 330). The display control block 335 may be further configured to output image frames to the display(s) 131 via the display interface 340. In some examples, the display control block 335 may additionally or alternatively perform post-processing of image data provided based on execution of the system memory 124 by the processing unit 120. The display interface 340 may be configured to cause the display(s) 131 to display image frames. The display interface 340 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 350.

In some such examples, the display processor 127 may not continuously refresh the graphical content of the display(s) 131. Instead, the display processor 127 may use a vertical synchronization (Vsync) pulse to coordinate rendering and consuming of graphical content at the buffer 350. For example, when a Vsync pulse is generated, the display processor 127 may output new graphical content to the buffer 350. Thus, generation of the Vsync pulse may indicate that current graphical content has been rendered at the buffer 350.

Frames are displayed at the display(s) 131 based on a display controller 345, a display client 355, and the buffer 350. The display controller 345 may receive image data from the display interface 340 and store the received image data in the buffer 350. In some examples, the display controller 345 may output the image data stored in the buffer 350 to the display client 355. Thus, the buffer 350 may represent a local memory to the display(s) 131. In some examples, the display controller 345 may output the image data received from the display interface 340 directly to the display client 355.

The display client 355 may be associated with a touch panel that senses interactions between a user and the display(s) 131. As the user interacts with the display(s) 131, one or more sensors in the touch panel may output signals to the display controller 345 that indicate which of the one or more sensors have sensor activity, a duration of the sensor activity, an applied pressure to the one or more sensor, etc. The display controller 345 may use the sensor outputs to determine a manner in which the user has interacted with the display(s) 131. The display(s) 131 may be further associated with/include other devices, such as a camera, a microphone, and/or a speaker, that operate in connection with the display client 355.

Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 310 may process a content buffer based on execution of an application that generates content on a pixel-by-pixel basis. During the composition and display stage(s), pixel elements may be assembled to form a frame that is transferred to a physical display panel/subsystem (e.g., the displays 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some aspects of display processing may utilize different types of mask layers, e.g., a shape mask layer. A mask layer is a layer that may represent a portion of a display or display panel. For instance, an area of a mask layer may correspond to an area of a display, but the entire mask layer may depict a portion of the content that is actually displayed at the display or panel. For example, a mask layer may include a top portion and a bottom portion of a display area, but the middle portion of the mask layer may be empty. In some examples, there may be multiple mask layers to represent different portions of a display area. Also, for certain portions of a display area, the content of different mask layers may overlap with one another. Accordingly, a mask layer may represent a portion of a display area that may or may not overlap with other mask layers.

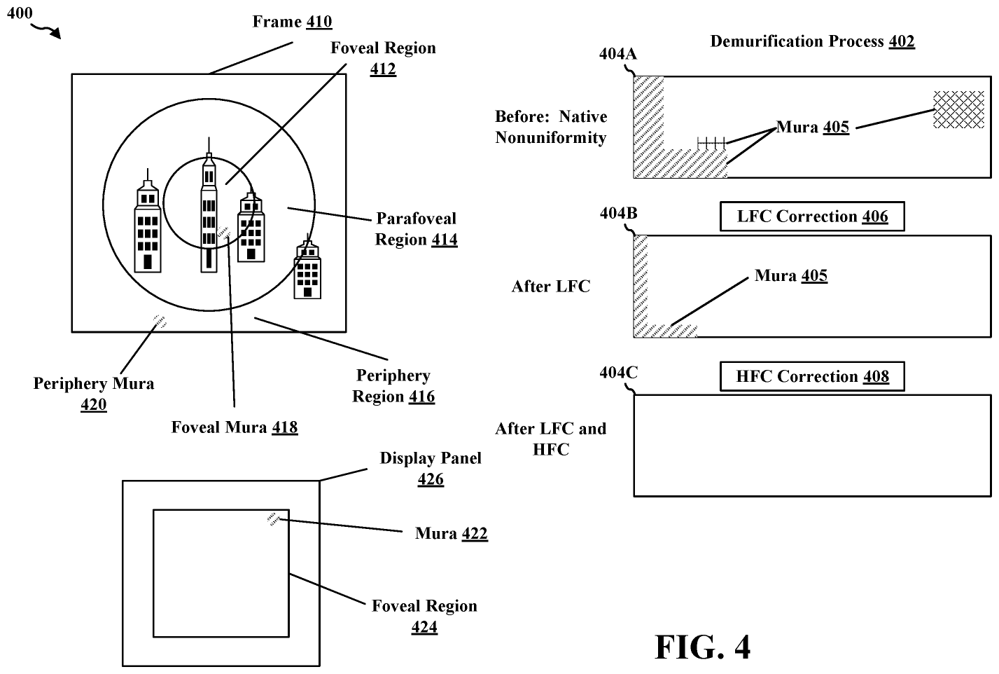

FIG. 4 is a diagram 400 illustrating example aspects pertaining to mura in accordance with one or more techniques of this disclosure. Mura may refer to a low-contrast irregular pattern or region on a display panel that causes uneven pixel uniformity on the display panel. Mura may cause pixels that are intended to display the same color to display different colors, which may impact a user experience, particularly in cases of XR applications. Mura may be caused by imperfections in a manufacturing process of a display panel.

The diagram 400 illustrates a demurification process 402. The demurification process 402 may alternatively be referred to as demurification, mura correction, demura correction, etc. There may be mura 405 (e.g., mura pixels) exhibited by pixels 404A on a display panel (e.g., the display(s) 131), that is, native nonuniformity may exist among the pixels 404A on the display panel. A display processor (e.g., the display processor 127) may perform an LFC correction 406 on the pixels 404A to produce pixels 404B. The LFC correction 406 may utilize a lookup table (LUT) to map colors of pixels exhibiting mura to a correct color such that the mura 405 may be mitigated. The LUT utilized by the LFC correction 406 may be configured for many different types of display panels.

After performing the LFC correction 406, the mura 405 may be mitigated; however, as illustrated in the diagram 400, the mura 405 may still be present. To further mitigate the mura 405, the display processor may perform an HFC correction 408 on the pixels 404B to produce pixels 404C. The HFC correction 408 may utilize direct memory access (DMA) operations and video and graphics (VIG) pipelines to further mitigate the mura 405. Unlike the LFC correction 406, the HFC correction 408 may be separately configured for different types of display panels. As illustrated in the diagram 400, after performing the HFC correction 408, the mura 405 may not be present in the pixels 404C. Thus, as described above, the demurification process 402 may be a two-step process (e.g., the LFC correction 406 and the HFC correction 408) that is applied across all pixels on a display panel.

Foveated rendering may refer to a rendering technique whereby different regions of an image are rendered at different quality levels (e.g., different resolutions) based on where a gaze of a user is directed. A resolution may refer to dimensions of pixels on a display panel or dimensions of a region on a display panel. In an example, a camera of a device (e.g., a camera of an XR device, such as an HMD) may track a fovea of an eye of the user as the user gazes on a display panel. The device may render a frame in which different regions of the frame have different quality levels. Foveated rendering may aid in conserving computing resources of the device, as regions of a frame that are less likely to be viewed in detail by a user (e.g., a periphery region) may be rendered with less detail and regions of the frame that are more likely to be viewed in detail by the user (e.g., a foveal region) may be rendered with more detail. In an example, for XR devices (e.g., VR devices), foveated rendering may be performed to enhance a user experience.

In an example, a device (e.g., the device 104) may render a frame 410 based on tracking an eye of a user via a camera. The frame 410 may include a foveal region 412, a parafoveal region 414, and a periphery region 416. The foveal region 412 (which may also be referred to as a fovea region) may be a region corresponding to a fovea of an eye of the user, that is, the fovea of the user may be oriented towards the foveal region 412. The fovea may refer to a small, central pit of the eye that includes closely packed cones. The fovea may be responsible for sharp central vision which is used by humans for activities that may need a relatively high amount of visual acuity, such as reading or driving. The parafoveal region 414 may correspond to a parafovea of the user. The parafovea of the user may be a region of an eye of the user that circumscribes the fovea. Visual acuity of the user may be less in the parafovea compared to visual acuity of the user in the fovea. The periphery region 416 may be a region corresponding to a perifovea of the user. The perifovea of the user may be a region of the eye of the user that circumscribes the parafovea. Visual acuity of the user may be less in the perifovea compared to visual acuity of the user in the parafovea.

In foveated rendering, the device may render the foveal region 412 at a first quality level, the parafoveal region 414 at a second quality level, and the periphery region at a third quality level, where the first quality level is greater than the second quality level, and where the second quality level is greater than the third quality level. In an example, the device may render the foveal region 412 at a first resolution, the parafoveal region 414 at a second resolution, and the periphery region at a third resolution, where the first resolution is greater than the second resolution, and where the second resolution is greater than the third resolution.

Mura may be exhibited by pixels associated with the frame 410 when the frame is presented on a display panel. For example, when displayed on a display panel, pixels associated with the frame 410 may exhibit foveal mura 418 in the foveal region 412 and periphery mura 420 in the periphery region 416. Some devices may perform demura correction regardless of where mura is exhibited on a display panel. For instance, a device may perform the LFC correction 406 and the HFC correction 408 if the foveal mura 418 is exhibited, if the periphery mura 420 is exhibited, or if both the foveal mura 418 and the periphery mura 420 is exhibited. Some aspects discussed herein pertain to performing the LFC correction 406 (and not performing the HFC correction 408) on pixels exhibiting mura when the pixels exhibiting the mura (e.g., the periphery mura 420) are located in the periphery region 416 in order to conserve battery power and/or computing resources of the device.

In another example, mura 422 may be exhibited by pixels that are within a foveal region 424 associated with a display panel 426, where the mura 422 may be located relatively close to an edge of the foveal region 424. The display panel 426 may be located relatively close (e.g., several centimeters) to an eye of a user. As such, the mura 422 may be perceivable by the user. Stated differently, discrepancies between panel colors and/or panel qualities may be perceivable by the user. As noted above, in foveated rendering, a quality of the foveal region 424 may be higher than a quality of other regions of the display panel 426. For instance, the foveal region 424 may be associated with a first resolution and the other regions may be associated with a second resolution, where the first resolution is greater than the second resolution. Applying demura correction may be associated with a reduction in quality of a frame displayed on the display panel 426. For instance, the demura correction may cause quality anomalies and/or color anomalies. Some aspects discussed herein pertain to modifying (e.g., reducing a size of) the foveal region 424 in order to push the mura 422 into a periphery region of the display panel 426, which may enable the (modified) foveal region 424 to be a focus of representation to a user.

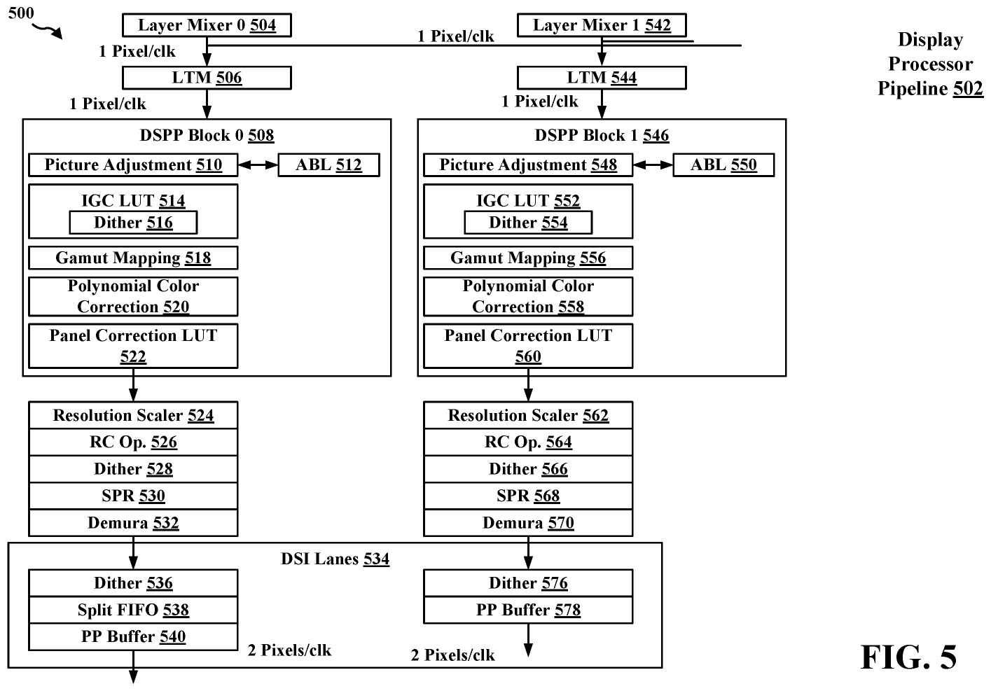

FIG. 5 is a diagram 500 illustrating an example display processor pipeline 502 in accordance with one or more techniques of this disclosure. In an example, the display processor pipeline 502 may be implemented in the device 104 and/or in the display processor 127.

A zeroth layer mixer (LM) 504 may obtain zeroth frame data from a DMA VIG pipeline (not shown in FIG. 5). In an example, the zeroth frame data may correspond to a frame that is to be presented for a left eye of a user. The zeroth frame data may be previously rendered by a graphics processor. The zeroth LM 504 may layer mix the zeroth frame data at a rate of one pixel per clock cycle. The zeroth LM 504 may operate in a line mode. Local tone mapping (LTM) 506 may then be performed on the zeroth frame data at a rate of one pixel per clock cycle.

A zeroth destination side post processing (DSPP) block 508 may obtain the zeroth frame data. The zeroth DSPP block 508 may perform a picture adjustment 510 on the zeroth frame data. The picture adjustment 510 may vary intensities of red, green, and/or blue primary colors. The picture adjustment 510 may be based on an adaptive backlight (ABL) 512 of a device. The zeroth DSPP block 508 may include an inverse gamma correction lookup table (IGC LUT) 514. The IGC LUT 514 may include optoelectrical functions that map electronically coded pixels (indicated by the zeroth frame data) to digitally coded pixels. The IGC LUT 514 may apply dither 516 to the zeroth frame data. The dither 516 may refer to noise used to randomize a quantization error in order to prevent large-scale patterns such as color banding in an image associated with the zeroth frame data. The zeroth DSPP block 508 may perform gamut mapping 518 on the zeroth frame data to map a source color gamut to a destination color gamut of a display panel. The zeroth DSPP block 508 may perform polynomial color correction 520 to filter certain colors (e.g., blues) out of the zeroth frame data. The zeroth DSPP block 508 may utilize a panel correction LUT 522 to adjust colors of the display panel based on a characteristics associated with a particular panel vendor.

The zeroth frame data may then undergo resolution scaling 524 to scale the zeroth frame data to a resolution of the display panel. The zeroth frame data may undergo a rounded corner (RC) operation 526 to account for rounded corners of the display panel and/or to account for camera(s) and/or microphone(s) on the display panel. Dither 528 may be applied to the zeroth frame data. The zeroth frame data may undergo subpixel rendering (SPR) 530. The SPR 530 may be used to convert a red green blue (RGB) color format associated with the zeroth frame data to a non-RGB color format supported by the display panel. Demura 532 (e.g., the LFC correction 406 and/or the HFC correction 408) may be applied to the zeroth frame data.

The zeroth frame data may then be transmitted to DSI lanes 534. The DSI lanes 534 may apply dither 536 to the zeroth frame data. The DSI lanes 534 may include a split first in, first out (FIFO) buffer 538 and a ping pong (PP) buffer 540 that may be used to manage and process the zeroth frame data. The DSI lanes 534 may be associated with 2 pixels per clock operations.

A first layer mixer (LM) 542 may obtain first frame data from a DMA VIG pipeline (not shown in FIG. 5). In an example, the first frame data may correspond to a frame that is to be presented for a right eye of a user. The first frame data may be previously rendered by a graphics processor. The first LM 542 may layer mix the first frame data at a rate of one pixel per clock cycle. The first LM 542 may operate in a line mode. LTM 544 may then be performed on the first frame data at a rate of one pixel per clock cycle.

A first DSPP block 546 may obtain the first frame data. The first DSPP block 546 may perform a picture adjustment 548 on the first frame data. The picture adjustment 548 may vary intensities of red, green, and/or blue primary colors. The picture adjustment 548 may be based on an ABL 550 of a device. The first DSPP block 546 may include an IGC LUT 552. The IGC LUT 552 may include optoelectrical functions that map electronically coded pixels (indicated by the first frame data) to digitally coded pixels. The IGC LUT 552 may apply dither 554 to the first frame data. The first DSPP block 546 may perform gamut mapping 556 on the first frame data to map a source color gamut to a destination color gamut of a display panel. The first DSPP block 546 may perform polynomial color correction 558 to filter certain colors (e.g., blues) out of the first frame data. The first DSPP block 546 may utilize a panel correction LUT 560 to adjust colors of the display panel based on a characteristics associated with a particular panel vendor.

The first frame data may then undergo resolution scaling 562 to scale the first frame data to a resolution of the display panel. The first frame data may undergo an RC operation 564 to account for rounded corners of the display panel and/or to account for camera(s) and/or microphone(s) on the display panel. Dither 566 may be applied to the first frame data. The first frame data may undergo SPR 568. The SPR 568 may be used to convert an RGB color format associated with the first frame data to a non-RGB color format supported by the display panel. Demura 570 (e.g., the LFC correction 406 and/or the HFC correction 408) may be applied to the first frame data. The first frame data may then be transmitted to the DSI lanes 534. The DSI lanes 534 may apply dither 576 to the first frame data. The DSI lanes 534 may include a PP buffer 578 that may be used to manage and process the first frame data. The DSI lanes 534 may be associated with 2 pixels per clock operations.

Aspects pertaining to the demura 532 (and the demura 570) are now described. In an example, if a mura pixel (i.e., a pixel exhibiting a mura effect) is in a periphery region, the device may perform LFC correction without performing HFC correction. With more particularity, the device may compare fovea left top right bottom (LTRB) coordinates with coordinates of a mura region on the display panel, where pixels in the mura region may be known to exhibit a mura effect. When the coordinates of the mura region are outside of the fovea LTRB coordinates, a defined flag may be set by a display manager (DM) and passed to a demura block (i.e., a hardware block associated with the demura 532, a hardware block associated with the demura 570) associated with a DSPP (e.g., the zeroth DSPP block 508, the first DSPP block 546). The demura block may read the flag and perform the LFC correction without performing the HFC correction. Data associated with the LFC correction may be used as an initial portion of a correction to reduce non-uniformity associated with the mura to a baseline level. The LFC corrected pixel data may be pushed to a display panel via DSI lanes. HFC correction may be associated with allocating DMA pipelines to read an HFC correction data layer, which may be computationally expensive and/or power intensive. Thus, by performing LFC correction without performing HFC correction, the device may conserve computational resources and/or power resources.

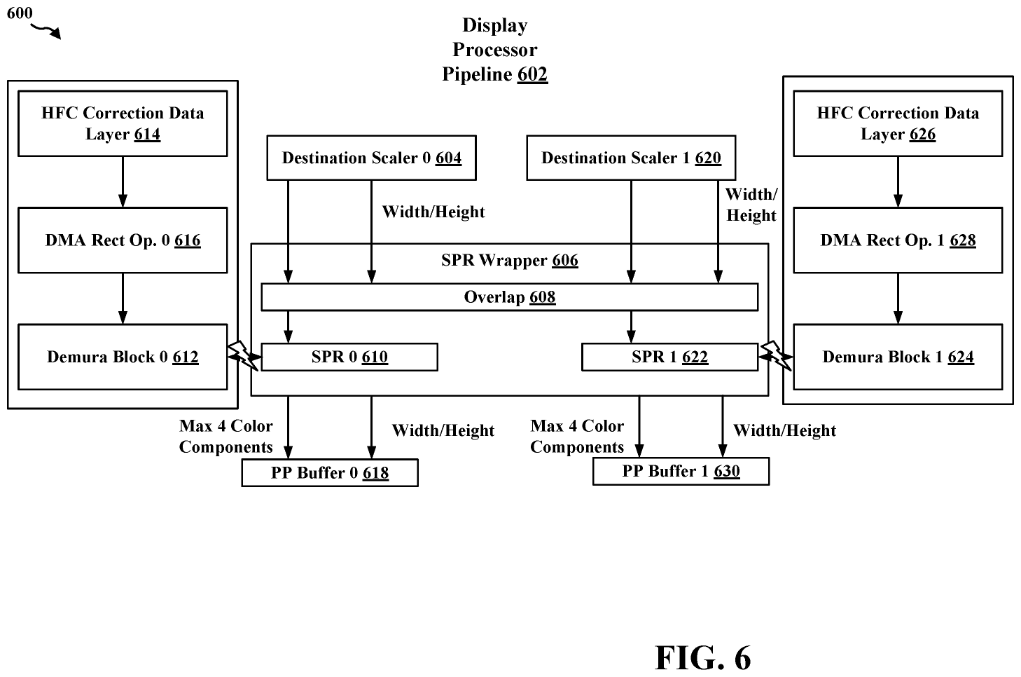

FIG. 6 is a diagram 600 illustrating an example of a display processor pipeline 602 in accordance with one or more techniques of this disclosure. A zeroth destination scaler 604 may obtain zeroth frame data and may perform scaling on the zeroth frame data. In an example, the zeroth frame data may correspond to a frame that is to be presented for a left eye of a user. The zeroth destination scaler 604 may be or include or be associated with the resolution scaling 524. The zeroth destination scaler 604 may provide the zeroth frame data and an indication of a height/width associated with the zeroth frame data to an SPR wrapper 606. The SPR wrapper 606 may include an overlap 608. The SPR wrapper 606 may include a zeroth subpixel processor 610 that may perform subpixel processing on the zeroth frame data. The zeroth subpixel processor 610 may be or include or be associated with the SPR 530.

A zeroth demura block 612 may be configured to perform an HFC correction (e.g., the HFC correction 408). The zeroth demura block 612 may be associated with the demura 532. When pixels exhibiting a mura effect are within a foveal region of a display panel, the zeroth demura block 612 may obtain HFC correction data from an HFC correction data layer 614 via a zeroth DMA rectangular operation 616 (which may be referred to as “DMA3 Rect 0”). When the pixels exhibiting the mura effect are within the periphery region of the display panel, the zeroth demura block 612 may not perform an HFC correction, and as such, the zeroth demura block 612, the HFC correction data layer 614, and the zeroth DMA rectangular operation 616 may be deactivated.

After demurification (e.g., an LFC correction without an HFC correction or an LFC correction and an HFC correction) is performed on the zeroth frame data, the SPR wrapper 606 may transmit the (corrected) zeroth frame data to a zeroth PP buffer 618, along with the indication of the height/width associated with the zeroth frame data. The zeroth PP buffer 618 may be or include or be associated with the PP buffer 540. The (corrected) zeroth frame data may be associated with a maximum of four color components. Zeroth graphical data may be presented on a zeroth display panel based on the (corrected) zeroth frame data.

A first destination scaler 620 may obtain first frame data and may perform scaling on the first frame data. In an example, the first frame data may correspond to a frame that is to be presented for a right eye of a user. The first destination scaler 620 may be or include or be associated with the resolution scaling 562. The first destination scaler 620 may provide the first frame data and an indication of a height/width associated with the first frame data to the SPR wrapper 606. The SPR wrapper 606 may include a first subpixel processor 622 that may perform subpixel processing on the first frame data. The first subpixel processor 622 may be or include or be associated with the SPR 568.

A first demura block 624 may be configured to perform an HFC correction (e.g., the HFC correction 408). The first demura block 624 may be associated with the demura 570. When pixels exhibiting a mura effect are within a foveal region of a display panel, the first demura block 624 may obtain HFC correction data from an HFC correction data layer 626 via a first DMA rectangular operation 628 (which may be referred to as “DMA3 Rect 1”). When the pixels exhibiting the mura effect are within the periphery region of the display panel, the first demura block 624 may not perform an HFC correction, and as such, the first demura block 624, the HFC correction data layer 626, and the first DMA rectangular operation 628 may be deactivated.

After demurification (e.g., an LFC correction without an HFC correction or an LFC correction and an HFC correction) is performed on the first frame data, the SPR wrapper 606 may transmit the (corrected) first frame data to a first PP buffer 630, along with the indication of the height/width associated with the first frame data. The first PP buffer 630 may be or include or be associated with the PP buffer 578. The (corrected) first frame data may be associated with a maximum of four color components. First graphical data may be presented on a first display panel based on the (corrected) first frame data.

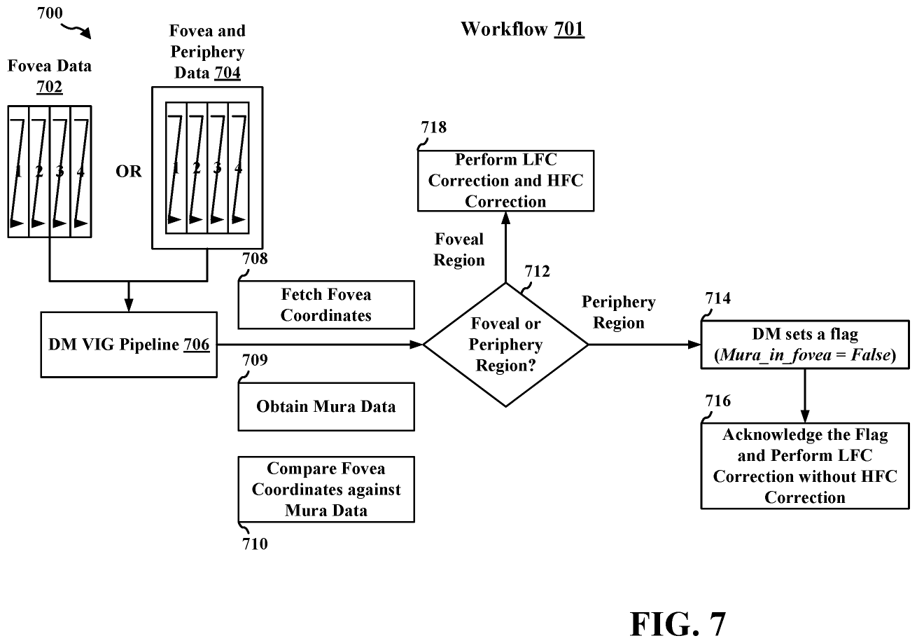

FIG. 7 is a diagram 700 illustrating an example of a workflow 701 for mura correction in accordance with one or more techniques of this disclosure. A display manager (DM) video and graphics (VIG) pipeline 706 of a device (e.g., the device 104) may obtain fovea data 702. The fovea data 702 may be indicative of a foveal region (e.g., the foveal region 412) of a display panel (e.g., the display(s) 131). Alternatively, the DM VIG pipeline 706 may obtain fovea and periphery data 704. The fovea and periphery data 704 may be indicative of the foveal region (e.g., the foveal region 412) and a periphery region 416 of the display panel. The fovea data 702 and/or the fovea and periphery data 704 may be based on an image of an eye of a user of the device captured by a camera of the device. The fovea data 702 and/or the fovea and periphery data 704 may also be based on frame(s) displayed by the device.

At 708, the DM VIG pipeline 706 may fetch fovea coordinates for a foveal region on the display panel based on the fovea data 702 or the fovea and periphery data 704. At 709, the DM VIG pipeline 706 may obtain mura data, where the mura data may be indicative of pixels on the display panel that exhibit mura. At 710, the DM VIG pipeline 706 may compare the fovea coordinates against the mura data. At 712, the DM VIG pipeline 706 may determine, based on the comparison, whether the pixels that exhibit the mura are within the fovea region or the periphery region.

Upon determining that the pixels that exhibit the mura are within the periphery region, at 714, a DM of the DM VIG pipeline 706 may set a flag (e.g., “Mura_in_fovea=False”). At 716, the DM may acknowledge the flag and the device may perform LFC correction (e.g., the LFC correction 406) without performing HFC correction (e.g., the HFC correction 408). Upon determining that the pixels exhibiting the mura are within the foveal region, at 718, the device may perform LFC correction (e.g., the LFC correction 406) and HFC correction (e.g., the HFC correction 408). Table 1 below details experimental results pertaining to the workflow 701.

TABLE 1
Results for Workflow 701

| | | | | Savings for |
|---|---|---|---|---|
| | | | | Fovea |
| | Without | With | With | (Assuming |
| Captured for | Demura | Demura HFC | Demura HFC | half of |
| 1080 × 2340 | (5 | Correction | Correction | a total |
| Resolution | seconds) | (5 seconds) | (10 seconds) | resolution) |
| Measured | 181.02085 | 183.61495 | 200.837 | — |
| Power (mA) | | | | |
| Delta mA | — | 2.5941 | 19.81615 | 9.95 |
| Delta mW | — | 9.85758 | 75.30137 | 37.5 |

As reflected in Table 1 above, the workflow 701 may be associated with power savings on a device. The workflow 701 may be associated with various advantages. For instance, the workflow 701 may trade quality in a periphery region (i.e., a non-focused area) for power savings. Furthermore, the workflow 701 may dynamically adapt to changes in a foveal region (e.g., by tracking an eye of the user via a camera). Additionally, the workflow 701 may be implemented at run-time and as an inline decision, and as such, the workflow 701 may not incur additional latency when implemented on a device.

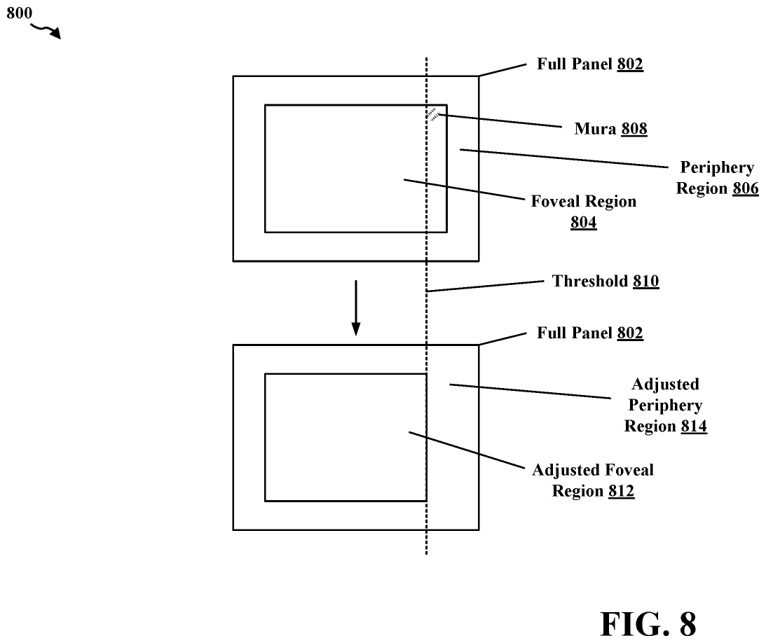

FIG. 8 is a diagram 800 illustrating an example of demurification in accordance with one or more techniques of this disclosure. Demurification may cause quality anomalies and/or color anomalies on a display panel. The quality anomalies and/or the color anomalies may be more perceivable by a user when the quality anomalies and/or the color anomalies are in a foveal region of the display panel compared to when the quality anomalies and/or the color anomalies are in the periphery region of the display panel.

Some aspects presented herein pertain to adjusting (e.g., reducing) a size of a foveal region on a display panel when a mura region (i.e., a region on the display panel that includes pixels exhibiting a mura effect) is (1) inside the foveal region and (2) within a threshold distance (or a threshold percentage) from an edge of the foveal region. Such an adjustment may push the mura region into a periphery region of the display panel, thereby enhancing a quality of the foveal region and improving user experience.

With more particularity, a display processor (e.g., a display processing unit (DPU)) may obtain (e.g., receive) coordinates for a foveal region on a display panel. In an example, the coordinates for the foveal region may be left top right bottom (LTRB) coordinates. The display processor may correlate the LTRB coordinates with coordinates for a mura region on a display panel. The mura region may be within the foveal region. The display processor may compute a distance between the mura region and an edge of the foveal region. The display processor may compare the distance to a threshold. If the distance is less than the threshold, the display processor may reduce the size of the foveal region in order to push the mura region into a periphery of the display panel. If the threshold is sufficiently small, an impact on user experience may be minimal and a quality of the foveal region may be improved.

The diagram 800 depicts a full panel 802 that includes a foveal region 804 and a periphery region 806. In an example, the foveal region 804 may have a resolution of 1000×1000 pixels. In an example, the foveal region 804 may include mura 808, that is, the foveal region 804 may include pixels that exhibit a mura effect. In an example, the mura 808 may correspond to a resolution of 50×1000 pixels. Using the process described above, a display processor may compute a distance of the mura 808 to an edge of the foveal region 804. The display processor may compare the distance to a threshold 810. In an example, the threshold 810 may be 5% from an edge of the foveal region 804. The display processor may adjust the foveal region 804 (and hence, the periphery region 806 as well) based on the comparison. In an example, if the distance is less than 5% from an edge of the foveal region 804, the display processor may reduce the size of the foveal region 804 (and increase a size of the periphery region 806) to generate an adjusted foveal region 812 and an adjusted periphery region 814, where a size of the adjusted foveal region 812 may be less than a size of the foveal region 804 and where a size of the adjusted periphery region 814 may be greater than a size of the periphery region 806. In an example, the size of the adjusted foveal region 812 may correspond to a resolution of 950×1000 pixels. For instance, the display processor may utilize a crop functionality of a VIG pipeline of the display processor to crop the mura 808 out of the foveal region 804 in order to push the mura 808 into the periphery region 806. Cropping may refer to a removal of an area of a frame.

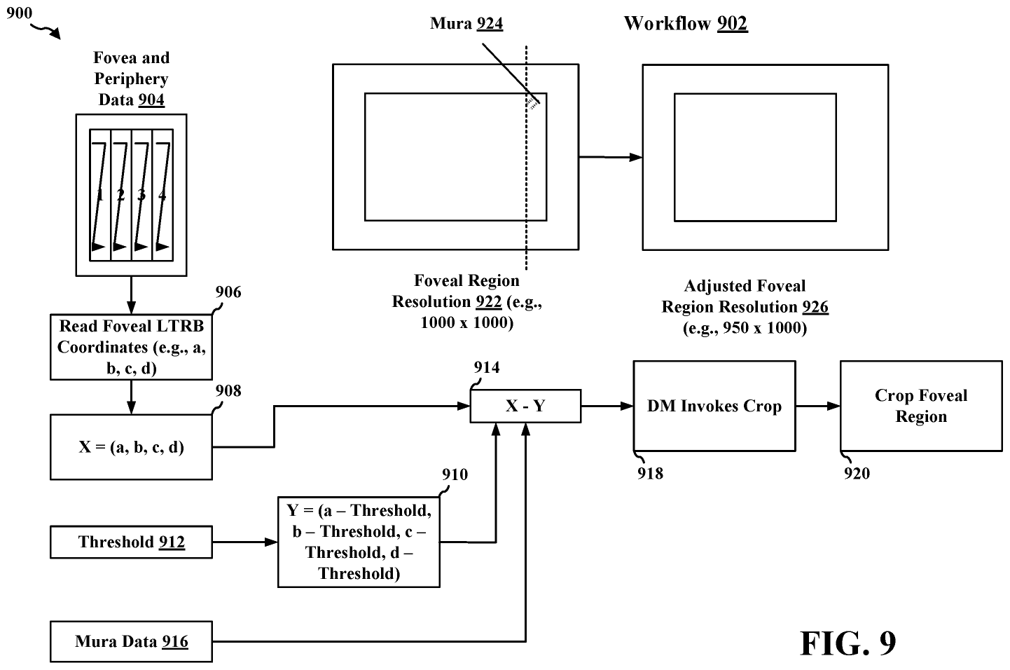

FIG. 9 is a diagram 900 illustrating an example of a workflow for mura correction in accordance with one or more techniques of this disclosure. A display processor (e.g., the display processor 127) of a device (e.g., the device 104) may obtain fovea and periphery data 904. The fovea and periphery data 904 may be indicative of a foveal region and a periphery region of the display panel. The fovea and periphery data 904 may be based on an image of an eye of a user of the device captured by a camera of the device. The fovea and periphery data 904 may also be based on frame(s) displayed by the device.

At 906, the display processor may read foveal LTRB coordinates from the fovea and periphery data 904. The foveal LTRB coordinates may correspond to a foveal region on a display panel of the device. In an example, the foveal LTRB coordinates may be “a, b, c, and d,” where each of “a, b, c, and d” may be a number that refers to a pixel on the display panel. At 908, the display processor may generate a vector X, where X includes “a, b, c, and d.”

At 910, the display processor may compute a vector Y based on the foveal LTRB coordinates and a threshold 912. For instance, the display processor may compute a difference between “a” and the threshold 912, a difference between “b” and the threshold 912, a difference between “c” and the threshold 912, and a difference between “d” and the threshold 912. In an example, the threshold may be 5%. In the example, the display processor may compute the vector Y as a difference between “a” and 5%, a difference between “b” and 5%, a difference between “c” and 5%, and a difference between “d” and 5%. In an example, the threshold 912 may be configured by an original equipment manufacturer (OEM) of the display panel. In another example, the threshold 912 may be modified by the OEM.

At 914, the display processor may compute a difference between the vector X and the vector Y. The display processor may obtain mura data 916, where the mura data 916 may be indicative of a mura region on the display panel. The display processor may determine whether the mura region is sufficiently close to an edge of the foveal region based on the difference and the mura data 916.

When the display processor determines that the mura region is sufficiently close to the edge of the foveal region, at 918, a DM of the display processor may invoke a crop functionality on the foveal region. At 920, the display processor may crop the foveal region based on the invocation. In an example, prior to the cropping, the foveal region may have a foveal region resolution 922 of 1000×1000 pixels. In the example, the foveal region may include mura 924 prior to the cropping. After the cropping, the foveal region may have an adjusted foveal region resolution 926 of 950×1000 pixels. The cropping may push the mura 924 into a periphery region of the display panel, which, as noted above, is less likely to be focused on by an eye of a user viewing the display panel. As the mura 924 is no longer located in the foveal region, a number of pixels processed in the fovea region for demura purposes may be reduced, which may reduce computational burdens on the device. For instance, cropping the foveal region may reduce a bandwidth used by a DPU client in run time cases. Equations (I) and (II) below demonstrate a first bandwidth used by a display processor that does not utilize foveal cropping as described above and a second bandwidth used by a display processor that utilizes foveal cropping as described above, respectively.

Bandwidth1=1000*1000(Foveal Region)*90(FPS)*8*8*8(8bit RGB Panel)=46,080,000,000 (I)

Bandwidth2=950*1000(Foveal Region)*90(FPS)*8*8*8(8bit RGB Panel)=43,776,000,000 (II)

As demonstrated by equations (I) and (II), foveal cropping may reduce a bandwidth used by a display processor. Furthermore, a difference between the first bandwidth and the second bandwidth may be correlated to processing and clock characteristics of the display processor. The workflow 902 may balance image quality with processing characteristics. The workflow 902 may mitigate or reduce anomalies by cropping the foveal region, which may improve a user experience. Furthermore, the workflow 902 may be adapted as a foveal region of the display panel changes, which may further improve the user experience.

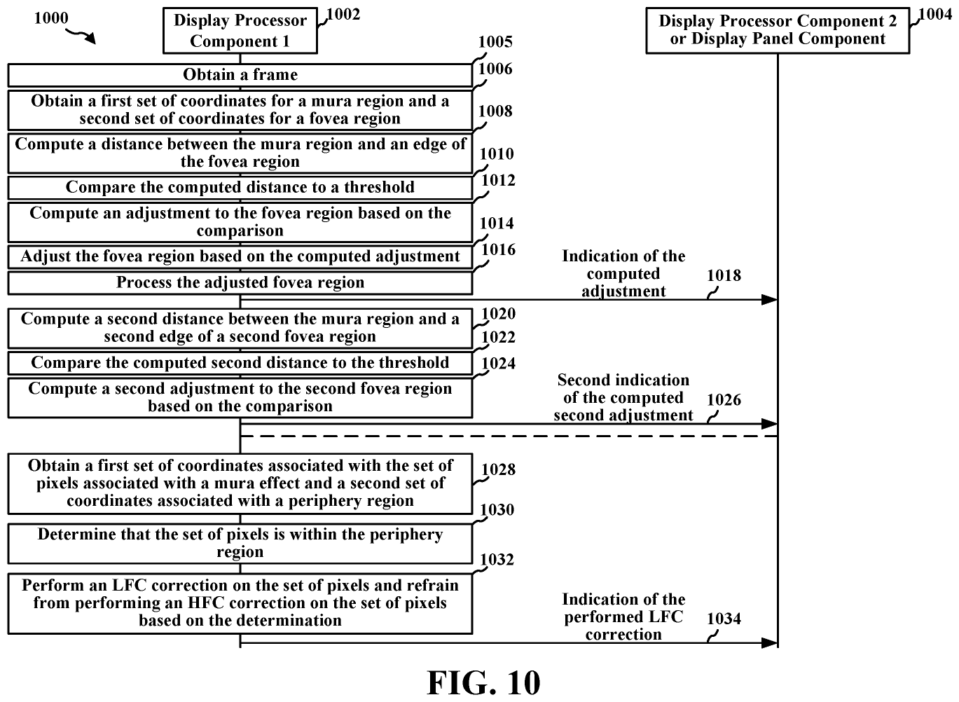

FIG. 10 is a call flow diagram 1000 illustrating example communications between a first display processor component 1002 and a second display processor component or a display panel component 1004 in accordance with one or more techniques of this disclosure. In an example, the first display processor component 1002 and the second display processor component or the display panel component 1004 may be included in the device 104.

At 1008, the first display processor component 1002 may compute a distance between a mura region on a display panel and an edge of a fovea region associated with a frame that is to be displayed on the display panel. At 1010, the first display processor component 1002 may compare the computed distance to a threshold. At 1012, the first display processor component 1002 may compute an adjustment to the fovea region based on the comparison of the computed distance to the threshold. At 1018, the first display processor component 1002 may output an indication of the computed adjustment to the fovea region (e.g., to the second display processor component or the display panel component 1004).

At 1014, the first display processor component 1002 may adjust, based on the computed adjustment, the fovea region associated with the frame subsequent to the computation of the adjustment to the fovea region, where outputting the indication of the computed adjustment to the fovea region at 1018 may include outputting an indication of the adjusted fovea region associated with the frame. At 1016, the first display processor component 1002 may process the adjusted fovea region associated with the frame.

At 1005, the first display processor component 1002 may obtain the frame. At 1006, the first display processor component 1002 may obtain a first set of coordinates for the mura region and a second set of coordinates for the fovea region, where computing the distance between the mura region and the fovea region at 1008 may include computing the distance based on the first set of coordinates and the second set of coordinates.

At 1020, the first display processor component 1002 may compute a second distance between the mura region on the display panel and a second edge of a second fovea region associated with a second frame that is to be displayed on the display panel, where the second fovea region is different from the fovea region. At 1022, the first display processor component 1002 may compare the computed second distance to the threshold. At 1024, the first display processor component 1002 may compute a second adjustment to the second fovea region based on the comparison of the computed second distance to the threshold. At 1026, the first display processor component 1002 may output (e.g., to the second display processor component or the display panel component 1004) a second indication of the computed second adjustment to the second fovea region.

At 1030, the first display processor component 1002 may determine that a set of pixels associated with a mura effect on the display panel is within a periphery region associated with the frame that is to be displayed on the display panel. At 1032, the first display processor component 1002 may perform a low frequency component (LFC) correction on the set of pixels and may refrain from performing a high frequency component (HFC) correction on the set of pixels based on the determination. At 1034, the first display processor component 1002 may output (e.g., to the second display processor component or the display panel component 1004) an indication of the performed LFC correction on the set of pixels. At 1028, the first display processor component 1002 may obtain a first set of coordinates associated with the set of pixels and a second set of coordinates associated with the periphery region, where determining that the set of pixels is within the periphery region at 1030 may include determining that the set of pixels is within the periphery region based on the first set of coordinates and the second set of coordinates. It is to be understood that 1028-1034 may be performed independently from 1005-1026, that is, 1028-1034 may be performed without performing 1005-1026 and 1005-1026 may be performed without performing 1028-1034.

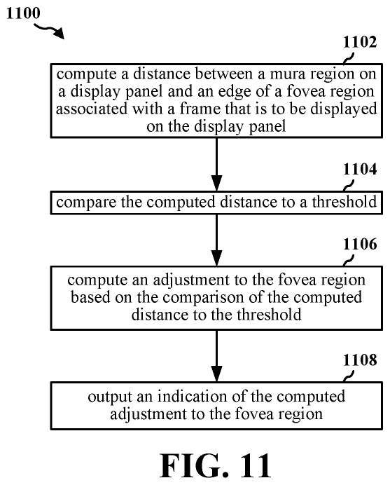

FIG. 11 is a flowchart 1100 of an example method of display processing in accordance with one or more techniques of this disclosure. The method may be performed by an apparatus, such as an apparatus for display processing, a display processing unit (DPU) or other display processor, the display processor 127, the display processor pipeline 502, the display processor pipeline 602, the device 104, the first display processor component 1002, a wireless communication device, and the like, as used in connection with the aspects of FIGS. 1-10. In an example, the method may be performed by the demura optimizer 198.

At 1102, the apparatus (e.g., a display processor) computes a distance between a mura region on a display panel and an edge of a fovea region associated with a frame that is to be displayed on the display panel. For example, FIG. 10 at 1008 shows that the first display processor component 1002 may compute a distance between a mura region on a display panel and an edge of a fovea region associated with a frame that is to be displayed on the display panel. In an example, the mura region may correspond to the mura 422 and the edge of the foveal region may correspond to the foveal region 424. In another example, the mura region may correspond to the mura 808 and the edge of the foveal region may correspond to the foveal region 804. In an example, the frame may be the frame 410. In an example, the display panel may be or include the display(s) 131. In an example, computing the distance may correspond to 914 in FIG. 9. In an example, 1102 may be performed by the demura optimizer 198.

At 1104, the apparatus (e.g., a display processor) compares the computed distance to a threshold. For example, FIG. 10 at 1010 shows that the first display processor component 1002 may compare the computed distance to a threshold. In an example, the threshold may be associated with the threshold 912. In an example, 1104 may be performed by the demura optimizer 198.

At 1106, the apparatus (e.g., a display processor) computes an adjustment to the fovea region based on the comparison of the computed distance to the threshold. For example, FIG. 10 at 1012 shows that the first display processor component 1002 may compute an adjustment to the fovea region based on the comparison of the computed distance to the threshold. In an example, the adjustment may correspond to the adjusted foveal region 812 and the adjusted periphery region 814. In an example, 1106 may be performed by the demura optimizer 198.

At 1108, the apparatus (e.g., a display processor) outputs an indication of the computed adjustment to the fovea region. For example, FIG. 10 at 1018 shows that the first display processor component 1002 may output an indication of the computed adjustment to the fovea region. For instance, the indication may be output to the second display processor component or the display panel component 1004. In an example, 1108 may be performed by the demura optimizer 198.

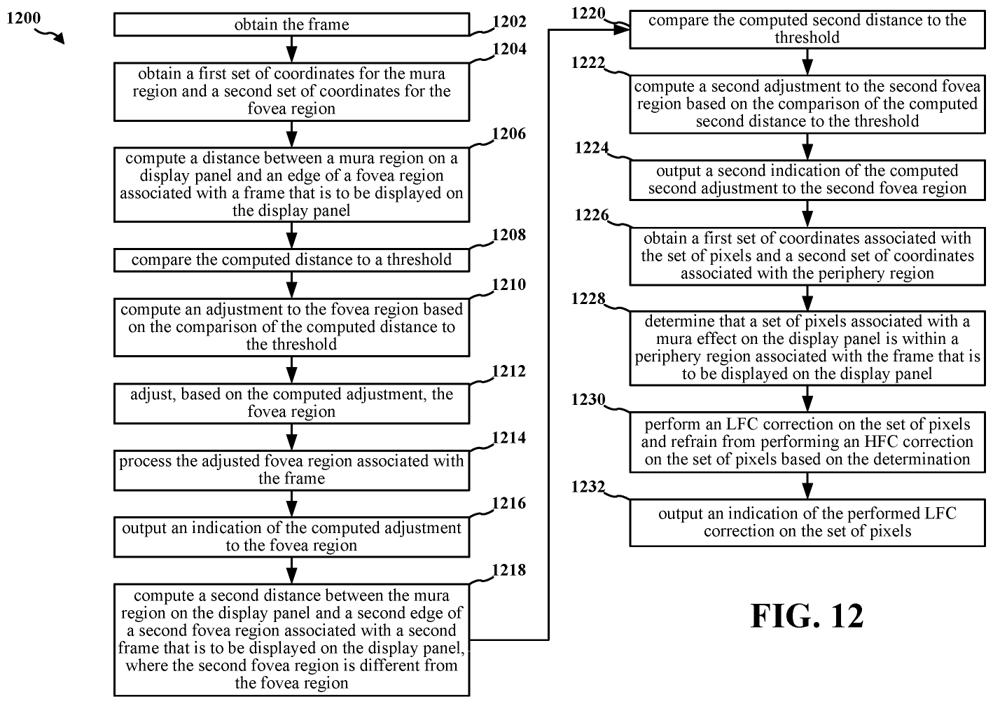

FIG. 12 is a flowchart 1200 of an example method of display processing in accordance with one or more techniques of this disclosure. The method may be performed by an apparatus, such as an apparatus for display processing, a display processing unit (DPU) or other display processor, the display processor 127, the display processor pipeline 502, the display processor pipeline 602, the device 104, the first display processor component 1002, a wireless communication device, and the like, as used in connection with the aspects of FIGS. 1-10. In an example, the method (including the various aspects below) may be performed by the demura optimizer 198.

At 1206, the apparatus (e.g., a display processor) computes a distance between a mura region on a display panel and an edge of a fovea region associated with a frame that is to be displayed on the display panel. For example, FIG. 10 at 1008 shows that the first display processor component 1002 may compute a distance between a mura region on a display panel and an edge of a fovea region associated with a frame that is to be displayed on the display panel. In an example, the mura region may correspond to the mura 422 and the edge of the foveal region may correspond to the foveal region 424. In another example, the mura region may correspond to the mura 808 and the edge of the foveal region may correspond to the foveal region 804. In an example, the frame may be the frame 410. In an example, the display panel may be or include the display(s) 131. In an example, computing the distance may correspond to 914 in FIG. 9. In an example, 1206 may be performed by the demura optimizer 198.

At 1208, the apparatus (e.g., a display processor) compares the computed distance to a threshold. For example, FIG. 10 at 1010 shows that the first display processor component 1002 may compare the computed distance to a threshold. In an example, the threshold may be associated with the threshold 912. In an example, 1208 may be performed by the demura optimizer 198.

At 1210, the apparatus (e.g., a display processor) computes an adjustment to the fovea region based on the comparison of the computed distance to the threshold. For example, FIG. 10 at 1012 shows that the first display processor component 1002 may compute an adjustment to the fovea region based on the comparison of the computed distance to the threshold. In an example, the adjustment may correspond to the adjusted foveal region 812 and the adjusted periphery region 814. In an example, 1210 may be performed by the demura optimizer 198.

At 1216, the apparatus (e.g., a display processor) outputs an indication of the computed adjustment to the fovea region. For example, FIG. 10 at 1018 shows that the first display processor component 1002 may output an indication of the computed adjustment to the fovea region. For instance, the indication may be output to the second display processor component or the display panel component 1004. In an example, 1216 may be performed by the demura optimizer 198.

In one aspect, at 1212, the apparatus (e.g., a display processor) may adjust, based on the computed adjustment, the fovea region associated with the frame subsequent to the computation of the adjustment to the fovea region, where outputting the indication of the computed adjustment to the fovea region may include outputting an indication of the adjusted fovea region associated with the frame. For example, FIG. 10 at 1014 shows that the first display processor component 1002 may adjust, based on the computed adjustment, the fovea region associated with the frame subsequent to the computation of the adjustment to the fovea region at 1012, where outputting the indication of the computed adjustment to the fovea region at 1018 may include outputting an indication of the adjusted fovea region associated with the frame. In an example, the aforementioned aspect may correspond to 918 and 920 in FIG. 9. In an example, adjusted foveal region may be the adjusted foveal region 812. In an example, 1212 may be performed by the demura optimizer 198.

In one aspect, at 1214, the apparatus (e.g., a display processor) may process the adjusted fovea region associated with the frame. For example, FIG. 10 at 1016 shows that the first display processor component 1002 may process the adjusted fovea region associated with the frame. In an example, the adjusted fovea region may be smaller than the foveal region, and as such, processing the adjusted fovea region may use less computational resources and/or power resources compared to processing the fovea region. In an example, 1214 may be performed by the demura optimizer 198.

In one aspect, adjusting the fovea region associated with the frame may include cropping a portion of the fovea region associated with the frame. For example, adjusting the fovea region associated with the frame at 1014 may include cropping a portion of the fovea region associated with the frame. In an example, the aforementioned aspect may correspond to 918 and 920 in FIG. 9. In another example, FIG. 8 shows that a portion of the fovea region may be cropped.

In one aspect, outputting the indication of the computed adjustment to the fovea region may include transmitting, to the display panel, the indication of the computed adjustment to the fovea region. For example, outputting the indication of the computed adjustment to the fovea region at 1018 may include transmitting, to the display panel, the indication of the computed adjustment to the fovea region. In one aspect, at 1204, the apparatus (e.g., a display processor) may obtain a first set of coordinates for the mura region and a second set of coordinates for the fovea region, where computing the distance between the mura region and the fovea region may include computing the distance based on the first set of coordinates and the second set of coordinates. For example, FIG. 10 at 1006 shows that the first display processor component 1002 may obtain a first set of coordinates for the mura region and a second set of coordinates for the fovea region, where computing the distance between the mura region and the fovea region at 1008 may include computing the distance based on the first set of coordinates and the second set of coordinates. In an example, the first set of coordinates may correspond to the mura data 916 and the second set of coordinates may correspond to 906 in FIG. 9. In an example, 1204 may be performed by the demura optimizer 198.

In one aspect, the frame may be associated with at least one of extended reality (XR) content, augmented reality (AR) content, mixed reality (MR) content, or virtual reality (VR) content. For example, the frame 410 may be associated with at least one of extended reality (XR) content, augmented reality (AR) content, mixed reality (MR) content, or virtual reality (VR) content.

In one aspect, at 1218, the apparatus (e.g., a display processor) may compute a second distance between the mura region on the display panel and a second edge of a second fovea region associated with a second frame that is to be displayed on the display panel, where the second fovea region may be different from the fovea region. For example, FIG. 10 at 1020 shows that the first display processor component 1002 may compute a second distance between the mura region on the display panel and a second edge of a second fovea region associated with a second frame that is to be displayed on the display panel, where the second fovea region may be different from the fovea region. In an example, 1218 may be performed by the demura optimizer 198.

In one aspect, at 1220, the apparatus (e.g., a display processor) may compare the computed second distance to the threshold. For example, FIG. 10 at 1022 shows that the first display processor component 1002 may compare the computed second distance to the threshold. In an example, 1220 may be performed by the demura optimizer 198.

In one aspect, at 1222, the apparatus (e.g., a display processor) may compute a second adjustment to the second fovea region based on the comparison of the computed second distance to the threshold. For example, FIG. 10 at 1024 shows that the first display processor component 1002 may compute a second adjustment to the second fovea region based on the comparison of the computed second distance to the threshold. In an example, 1222 may be performed by the demura optimizer 198.

In one aspect, at 1224, the apparatus (e.g., a display processor) may output a second indication of the computed second adjustment to the second fovea region. For example, FIG. 10 at 1026 shows that the first display processor component 1002 may output (e.g., to the second display processor component or the display panel component 1004) a second indication of the computed second adjustment to the second fovea region. In an example, 1224 may be performed by the demura optimizer 198.

In one aspect, the mura region may include a set of pixels on the display panel, and the set of pixels may be associated with a mura effect. For example, the mura 422 or the mura 808 may be the mura region which may include a set of pixels on the display panel, and the set of pixels may be associated with a mura effect.

In one aspect, the threshold may be associated with the fovea region. For example, the threshold at 1010 may be associated with the foveal region 424 or the foveal region 804.

In one aspect, the mura region may be within the fovea region on the display panel. For example, FIG. 8 shows that the mura 808 may be within the foveal region 804.

In one aspect, the fovea region may be associated with a first resolution, the computed adjustment to the fovea region may be associated with a second resolution, and the second resolution may be less than the first resolution. For example, the first resolution may be the foveal region resolution 922 (e.g., 1000×1000) and the second resolution may be the adjusted foveal region resolution 926 (e.g., 950×1000).

In one aspect, at 1228, the apparatus (e.g., a display processor) may determine that a set of pixels associated with a mura effect on the display panel is within a periphery region associated with the frame that is to be displayed on the display panel. For example, FIG. 10 at 1030 shows that the first display processor component 1002 may determine that a set of pixels associated with a mura effect on the display panel is within a periphery region associated with the frame that is to be displayed on the display panel. In an example, the periphery region may be the periphery region 416 and the set of pixels associated with the mura effect may correspond to the periphery mura 420. In an example, the aforementioned aspect may correspond to 712 in FIG. 7. In an example, 1228 may be performed by the demura optimizer 198.

In one aspect, at 1230, the apparatus (e.g., a display processor) may perform a low frequency component (LFC) correction on the set of pixels and may refrain from performing a high frequency component (HFC) correction on the set of pixels based on the determination. For example, FIG. 10 at 1032 shows that the first display processor component 1002 may perform a low frequency component (LFC) correction on the set of pixels and may refrain from performing a high frequency component (HFC) correction on the set of pixels based on the determination at 1030. In an example, the LFC correction may be the LFC correction 406 and the HFC correction may be the HFC correction 408. In an example, the aforementioned aspect may correspond to 714 and 716 in FIG. 7. In an example, 1230 may be performed by the demura optimizer 198.

In one aspect, at 1232, the apparatus (e.g., a display processor) may output an indication of the performed LFC correction on the set of pixels. For example, FIG. 10 at 1034 shows that the first display processor component 1002 may output (e.g., to the second display processor component or the display panel component 1004) an indication of the performed LFC correction on the set of pixels. In an example, 1232 may be performed by the demura optimizer 198.

In one aspect, outputting the indication of the performed LFC correction on the set of pixels may include storing the indication of the performed LFC correction in at least one of a memory, a buffer, or a cache. For example, outputting the indication of the performed LFC correction on the set of pixels at 1034 may include storing the indication of the performed LFC correction in at least one of a memory, a buffer, or a cache

In one aspect, outputting the indication of the performed LFC correction on the set of pixels may include transmitting, to the display panel, the indication of the performed LFC correction. For example, outputting the indication of the performed LFC correction on the set of pixels at 1034 may include transmitting, to the display panel, the indication of the performed LFC correction.

In one aspect, the periphery region on the display panel may be outside of the fovea region associated with the frame. For example, FIG. 4 shows that the periphery region 416 may be outside of the foveal region 412.

In one aspect, at 1226, the apparatus (e.g., a display processor) may obtain a first set of coordinates associated with the set of pixels and a second set of coordinates associated with the periphery region, where determining that the set of pixels is within the periphery region may include determining that the set of pixels is within the periphery region based on the first set of coordinates and the second set of coordinates. For example, FIG. 10 at 1028 shows that the first display processor component 1002 may obtain a first set of coordinates associated with the set of pixels and a second set of coordinates associated with the periphery region, where determining that the set of pixels is within the periphery region at 1030 may include determining that the set of pixels is within the periphery region based on the first set of coordinates and the second set of coordinates. In an example, the first set of coordinates may correspond to 709 and the second set of coordinates and the second set of coordinates may correspond to 708. In an example, 1226 may be performed by the demura optimizer 198.

In one aspect, the LFC correction may be associated with a lookup table (LUT) including mappings of colors of the set of pixels to corrected colors of the set of pixels, and where performing the LFC correction on the set of pixels may include performing the LFC correction via the LUT, and where the HFC correction is associated with a direct memory access (DMA) pipeline. For example, the LFC correction 406 may be associated with a lookup table (LUT) including mappings of colors of the set of pixels to corrected colors of the set of pixels, where performing the LFC correction on the set of pixels at 1032 may include performing the LFC correction via the LUT. In an example, the HFC correction 408 may be associated with the zeroth DMA rectangular operation 616 or the first DMA rectangular operation 628.

In one aspect, outputting the indication of the performed LFC correction on the set of pixels may include outputting the indication of the performed LFC correction on the set of pixels and an indication of the refrainment from performing the HFC correction on the set of pixels. For example, outputting the indication of the performed LFC correction on the set of pixels at 1034 may include outputting the indication of the performed LFC correction on the set of pixels and an indication of the refrainment from performing the HFC correction on the set of pixels.

In one aspect, at 1202, the apparatus (e.g., a display processor) may obtain the frame. For example, FIG. 10 at 1005 shows that the first display processor component 1002 may obtain the frame. In an example, 1202 may be performed by the demura optimizer 198.

In configurations, a method or an apparatus for display processing is provided. The apparatus may be a DPU, a display processor, or some other processor that may perform display processing. In aspects, the apparatus may be the display processor 127 within the device 104, or may be some other hardware within the device 104 or another device. The apparatus may include means for computing a distance between a mura region on a display panel and an edge of a fovea region associated with a frame that is to be displayed on the display panel. The apparatus may further include means for comparing the computed distance to a threshold. The apparatus may further include means for computing an adjustment to the fovea region based on the comparison of the computed distance to the threshold. The apparatus may further include means for outputting an indication of the computed adjustment to the fovea region. The apparatus may further include means for adjusting, based on the computed adjustment, the fovea region associated with the frame subsequent to the computation of the adjustment to the fovea region, where outputting the indication of the computed adjustment to the fovea region includes outputting an indication of the adjusted fovea region associated with the frame. The apparatus may further include means for obtaining a first set of coordinates for the mura region and a second set of coordinates for the fovea region, where computing the distance between the mura region and the fovea region includes computing the distance based on the first set of coordinates and the second set of coordinates. The apparatus may further include means for computing a second distance between the mura region on the display panel and a second edge of a second fovea region associated with a second frame that is to be displayed on the display panel, where the second fovea region is different from the fovea region. The apparatus may further include means for comparing the computed second distance to the threshold. The apparatus may further include means for computing a second adjustment to the second fovea region based on the comparison of the computed second distance to the threshold. The apparatus may further include means for outputting a second indication of the computed second adjustment to the second fovea region. The apparatus may further include means for determining that a set of pixels associated with a mura effect on the display panel is within a periphery region associated with the frame that is to be displayed on the display panel. The apparatus may further include means for performing a low frequency component (LFC) correction on the set of pixels and refraining from performing a high frequency component (HFC) correction on the set of pixels based on the determination. The apparatus may further include means for outputting an indication of the performed LFC correction on the set of pixels. The apparatus may further include means for obtaining a first set of coordinates associated with the set of pixels and a second set of coordinates associated with the periphery region, where determining that the set of pixels is within the periphery region includes determining that the set of pixels is within the periphery region based on the first set of coordinates and the second set of coordinates. The apparatus may further include means for obtaining the frame.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of display processing, comprising: computing a distance between a mura region on a display panel and an edge of a fovea region associated with a frame that is to be displayed on the display panel; comparing the computed distance to a threshold; computing an adjustment to the fovea region based on the comparison of the computed distance to the threshold; and outputting an indication of the computed adjustment to the fovea region.

Aspect 2 may be combined with aspect 1, and further comprises: adjusting, based on the computed adjustment, the fovea region associated with the frame subsequent to the computation of the adjustment to the fovea region, wherein outputting the indication of the computed adjustment to the fovea region includes outputting an indication of the adjusted fovea region associated with the frame.

Aspect 3 may be combined with aspect 2, and further comprises: processing the adjusted fovea region associated with the frame.

Aspect 4 may be combined with any of aspects 2-3, wherein adjusting the fovea region associated with the frame includes cropping a portion of the fovea region associated with the frame.

Aspect 5 may be combined with any of aspects 1-4, wherein outputting the indication of the computed adjustment to the fovea region includes transmitting, to the display panel, the indication of the computed adjustment to the fovea region.

Aspect 6 may be combined with any of aspects 1-5, and further comprises: obtaining a first set of coordinates for the mura region and a second set of coordinates for the fovea region, wherein computing the distance between the mura region and the fovea region includes computing the distance based on the first set of coordinates and the second set of coordinates.

Aspect 7 may be combined with any of aspects 1-6, wherein the frame is associated with at least one of extended reality (XR) content, augmented reality (AR) content, mixed reality (MR) content, or virtual reality (VR) content.

Aspect 8 may be combined with any of aspects 1-7, and further comprises: computing a second distance between the mura region on the display panel and a second edge of a second fovea region associated with a second frame that is to be displayed on the display panel, wherein the second fovea region is different from the fovea region; comparing the computed second distance to the threshold; computing a second adjustment to the second fovea region based on the comparison of the computed second distance to the threshold; and outputting a second indication of the computed second adjustment to the second fovea region.

Aspect 9 may be combined with any of aspects 1-8, wherein the mura region includes a set of pixels on the display panel, and wherein the set of pixels is associated with a mura effect.

Aspect 10 may be combined with any of aspects 1-9, wherein the threshold is associated with the fovea region.

Aspect 11 may be combined with any of aspects 1-10, wherein the mura region is within the fovea region on the display panel.

Aspect 12 may be combined with any of aspects 1-11, wherein the fovea region is associated with a first resolution, wherein the computed adjustment to the fovea region is associated with a second resolution, and wherein the second resolution is less than the first resolution.

Aspect 13 may be combined with any of aspects 1-12, and further comprises: determining that a set of pixels associated with a mura effect on the display panel is within a periphery region associated with the frame that is to be displayed on the display panel; performing a low frequency component (LFC) correction on the set of pixels and refraining from performing a high frequency component (HFC) correction on the set of pixels based on the determination; and outputting an indication of the performed LFC correction on the set of pixels.

Aspect 14 may be combined with aspect 13, wherein outputting the indication of the performed LFC correction on the set of pixels includes storing the indication of the performed LFC correction in at least one of a memory, a buffer, or a cache.

Aspect 15 may be combined with any of aspects 13-14, wherein outputting the indication of the performed LFC correction on the set of pixels includes transmitting, to the display panel, the indication of the performed LFC correction.

Aspect 16 may be combined with any of aspects 13-15, wherein the periphery region on the display panel is outside of the fovea region associated with the frame.

Aspect 17 may be combined with any of aspects 13-16, and further comprises: obtaining a first set of coordinates associated with the set of pixels and a second set of coordinates associated with the periphery region, wherein determining that the set of pixels is within the periphery region includes determining that the set of pixels is within the periphery region based on the first set of coordinates and the second set of coordinates.

Aspect 18 may be combined with any of aspects 13-17, wherein the LFC correction is associated with a lookup table (LUT) including mappings of colors of the set of pixels to corrected colors of the set of pixels, and wherein performing the LFC correction on the set of pixels includes performing the LFC correction via the LUT, and wherein the HFC correction is associated with a direct memory access (DMA) pipeline.

Aspect 19 may be combined with any of aspects 13-18, wherein outputting the indication of the performed LFC correction on the set of pixels includes outputting the indication of the performed LFC correction on the set of pixels and an indication of the refrainment from performing the HFC correction on the set of pixels.

Aspect 20 is an apparatus for display processing comprising a processor coupled to a memory and, based on information stored in the memory, the processor is configured to implement a method as in any of aspects 1-19.

Aspect 21 may be combined with aspect 20 and comprises that the apparatus is a wireless communication device comprising at least one of a transceiver or an antenna coupled to the processor, wherein the processor is further configured to obtain the frame via at least one of the transceiver or the antenna.

Aspect 22 is an apparatus for display processing comprising means for implementing a method as in any of aspects 1-19.

Aspect 23 is a computer-readable medium (e.g., a non-transitory computer readable-medium) storing computer executable code, the computer executable code, when executed by a processor, causes the processor to implement a method as in any of aspects 1-19.

Various aspects have been described herein. These and other aspects are within the scope of the following claims.

What is claimed is:

1. An apparatus for display processing, comprising:
a memory; and
a processor coupled to the memory and, based on information stored in the memory, the processor is configured to:
compute a distance between a mura region on a display panel and an edge of a fovea region associated with a frame that is to be displayed on the display panel;
compare the computed distance to a threshold;
compute an adjustment to the fovea region based on the comparison of the computed distance to the threshold; and
output an indication of the computed adjustment to the fovea region.

2. The apparatus of claim 1, wherein the processor is further configured to:
adjust, based on the computed adjustment, the fovea region associated with the frame subsequent to the computation of the adjustment to the fovea region, wherein to output the indication of the computed adjustment to the fovea region, the processor is configured to output an indication of the adjusted fovea region associated with the frame.

3. The apparatus of claim 2, wherein the processor is further configured to:
process the adjusted fovea region associated with the frame.

4. The apparatus of claim 2, wherein to adjust the fovea region associated with the frame, the processor is configured to crop a portion of the fovea region associated with the frame.

5. The apparatus of claim 1, wherein to output the indication of the computed adjustment to the fovea region, the processor is configured to transmit, to the display panel, the indication of the computed adjustment to the fovea region.

6. The apparatus of claim 1, wherein the processor is further configured to:
obtain a first set of coordinates for the mura region and a second set of coordinates for the fovea region, wherein to compute the distance between the mura region and the fovea region, the processor is configured to compute the distance based on the first set of coordinates and the second set of coordinates.

7. The apparatus of claim 1, wherein the frame is associated with at least one of extended reality (XR) content, augmented reality (AR) content, mixed reality (MR) content, or virtual reality (VR) content.

8. The apparatus of claim 1, wherein the processor is further configured to:
compute a second distance between the mura region on the display panel and a second edge of a second fovea region associated with a second frame that is to be displayed on the display panel, wherein the second fovea region is different from the fovea region;
compare the computed second distance to the threshold;
compute a second adjustment to the second fovea region based on the comparison of the computed second distance to the threshold; and
output a second indication of the computed second adjustment to the second fovea region.

9. The apparatus of claim 1, wherein the mura region comprises a set of pixels on the display panel, and wherein the set of pixels is associated with a mura effect.

10. The apparatus of claim 1, wherein the threshold is associated with the fovea region.

11. The apparatus of claim 1, wherein the mura region is within the fovea region on the display panel.

12. The apparatus of claim 1, wherein the fovea region is associated with a first resolution, wherein the computed adjustment to the fovea region is associated with a second resolution, and wherein the second resolution is less than the first resolution.

13. The apparatus of claim 1, wherein the processor is further configured to:
determine that a set of pixels associated with a mura effect on the display panel is within a periphery region associated with the frame that is to be displayed on the display panel;
perform a low frequency component (LFC) correction on the set of pixels and refrain from performing a high frequency component (HFC) correction on the set of pixels based on the determination; and
output an indication of the performed LFC correction on the set of pixels.

14. The apparatus of claim 13, wherein to output the indication of the performed LFC correction on the set of pixels, the processor is configured to store the indication of the performed LFC correction in at least one of the memory, a buffer, or a cache.

15. The apparatus of claim 13, wherein to output the indication of the performed LFC correction on the set of pixels, the processor is configured to transmit, to the display panel, the indication of the performed LFC correction.

16. The apparatus of claim 13, wherein the periphery region on the display panel is outside of the fovea region associated with the frame.

17. The apparatus of claim 13, wherein the processor is further configured to:
obtain a first set of coordinates associated with the set of pixels and a second set of coordinates associated with the periphery region, wherein to determine that the set of pixels is within the periphery region, the processor is configured to determine that the set of pixels is within the periphery region based on the first set of coordinates and the second set of coordinates.

18. The apparatus of claim 13, wherein the LFC correction is associated with a lookup table (LUT) comprising mappings of colors of the set of pixels to corrected colors of the set of pixels, and wherein to perform the LFC correction on the set of pixels, the processor is configured to perform the LFC correction via the LUT, and wherein the HFC correction is associated with a direct memory access (DMA) pipeline.

19. The apparatus of claim 13, wherein to output the indication of the performed LFC correction on the set of pixels, the processor is configured to output the indication of the performed LFC correction on the set of pixels and an indication of the refrainment from performing the HFC correction on the set of pixels.

20. The apparatus of claim 1, further comprising at least one of a transceiver or an antenna coupled to the processor, wherein the processor is further configured to obtain the frame via at least one of the transceiver or the antenna.

21. A method of display processing, comprising:
computing a distance between a mura region on a display panel and an edge of a fovea region associated with a frame that is to be displayed on the display panel;
comparing the computed distance to a threshold;
computing an adjustment to the fovea region based on the comparison of the computed distance to the threshold; and
outputting an indication of the computed adjustment to the fovea region.

22. The method of claim 21, further comprising:
adjusting, based on the computed adjustment, the fovea region associated with the frame subsequent to the computation of the adjustment to the fovea region, wherein outputting the indication of the computed adjustment to the fovea region comprises outputting an indication of the adjusted fovea region associated with the frame.

23. The method of claim 22, further comprising:
processing the adjusted fovea region associated with the frame.

24. The method of claim 22, wherein adjusting the fovea region associated with the frame comprises cropping a portion of the fovea region associated with the frame.

25. The method of claim 21, wherein outputting the indication of the computed adjustment to the fovea region comprises transmitting, to the display panel, the indication of the computed adjustment to the fovea region.

26. The method of claim 21, further comprising:
obtaining a first set of coordinates for the mura region and a second set of coordinates for the fovea region, wherein computing the distance between the mura region and the fovea region comprises computing the distance based on the first set of coordinates and the second set of coordinates.

27. The method of claim 21, wherein the frame is associated with at least one of extended reality (XR) content, augmented reality (AR) content, mixed reality (MR) content, or virtual reality (VR) content.

28. The method of claim 21, further comprising:
computing a second distance between the mura region on the display panel and a second edge of a second fovea region associated with a second frame that is to be displayed on the display panel, wherein the second fovea region is different from the fovea region;
comparing the computed second distance to the threshold;
computing a second adjustment to the second fovea region based on the comparison of the computed second distance to the threshold; and
outputting a second indication of the computed second adjustment to the second fovea region.

29. The method of claim 21, wherein the mura region comprises a set of pixels on the display panel, and wherein the set of pixels is associated with a mura effect.

30. A computer-readable medium storing computer executable code, the computer executable code, when executed by a processor, causes the processor to:
compute a distance between a mura region on a display panel and an edge of a fovea region associated with a frame that is to be displayed on the display panel;
compare the computed distance to a threshold;
compute an adjustment to the fovea region based on the comparison of the computed distance to the threshold; and
output an indication of the computed adjustment to the fovea region.
